(19) United States
(12) Patent Application Publication
(10) Pub. No.: US 2017/0011595 A1
(43) Pub. Date: Jan. 12, 2017

(54) ONLINE CHALLENGE GAME METHOD, ONLINE CHALLENGE GAME SYSTEM AND METHOD FOR CALCULATING ADVERTISEMENT COSTS

(71) Applicant: Hyong-suk KIM, Gwangju (KR)

(72) Inventor: Hyong-suk KIM, Gwangju (KR)

(73) Assignees: M-BIZ GLOBAL SOLUTIONS GMBH, Luzern (CH); Hyong-suk KIM, Buk-gu (KR)

(21) Appl. No.: 14/796,272

(22) Filed: Jul. 10, 2015

(51) Int. Cl. G07F 17/32

(52) U.S. Cl. CPC G07F 17/3255

(57) ABSTRACT

An online challenge game method determines a winner by comparing a challenger's total game score (TGS1=SGS1+AGS1) which is the sum of a single game score (SGS1) obtained through a terminal of the challenger and an advertisement game score (AGS1) obtained by playing an advertisement game provided during an online challenge with a total game score (TGS2=SGS2+AGS2) which is the sum of a single game score (SGS2) obtained through a terminal of a non-challenger and an advertisement game score (AGS2) obtained by playing an advertisement game provided when the online challenge is accepted.

### THE ART TO WHICH THE INVENTIVE CONCEPT

Example embodiments generally relate to an online challenge game method, an online challenge game system and a method for calculating advertisement costs, and more particularly relate to an online challenge game method, an online challenge game system and a method for calculating advertisement costs in which a winner is determined by comparing single game scores, which are acquired by wireless terminals, with each other on online.

### BACKGROUND OF THE INVENTIVE CONCEPT

As high speed wireless network technologies advance, mobile games performed on wireless terminals, such as smart phones, have been developed. Contrary to a personal computer (PC), a wireless terminal has restrictions in a size and a hardware specification. Therefore, a mobile game is usually a simple single game rather than a masterpiece. In a game server, a competition among game users is encouraged by publishing game rankings of the game users for a single game on online.

Generally, game developers or game publishers attract advertisers based on the number of game users, and their main profit model is an advertising revenue that is earned through exposures of advertisements on a game screen.

However, since a banner advertisement type or a popup advertisement type is used to expose the advertisements on a game screen, the advertisement is displayed on a small portion of the small display. Therefore, this kind of advertisement is not efficient unless the game users actively try to recognize the advertisement. In addition, since advertising contents are distributed to unspecified individuals, the game users may have resistance against the advertising contents such that negative effects may be caused.

For this reason, advertisers may not want to put an advertisement in the game such that a profit mode of the game developer or the game publisher may get worse.

### CONTENT OF THE INVENTIVE CONCEPT

### Technical Object of the Inventive Concept

Some example embodiments of the inventive concept provide an online challenge game method and an online challenge game system capable of increasing users' interests based on a competition and a reward in relation with a single game.

Some example embodiments of the inventive concept provide an online challenge game method and an online challenge game system capable of increasing an exposure level of an advertisement by encouraging game users to voluntarily download an advertisement game, which includes an advertisement, by providing an additional score when the game uses play the advertisement game.

Some example embodiments of the inventive concept provide an online challenge game method and an online challenge game system capable of encouraging game users to competitively download an advertisement game, which includes an advertisement, by providing an additional score when the game uses play the advertisement game and giving a gift card based on the additional score.

Some example embodiments of the inventive concept provide an online challenge game method and an online challenge game system capable of increasing unit cost of an advertisement by guaranteeing an exposure of the advertisement through an advertisement game, which includes the advertisement.

Some example embodiments of the inventive concept provide a method for calculating advertisement costs capable of providing an advertisement cost based on an exposure time of the advertisement, which is calculated by counting play time of the advertisement game.

### Means for Achieving the Technical Object

In a method for an online challenge game, a winner is determined by comparing a total game score (TGS1=SGS1+AGS1) of a challenger, which corresponds to a sum of a single game score SGS1 acquired through a terminal of the challenger and an advertising game score AGS1 acquired by playing an advertising game that is provided during an online challenge, with a total game score (TGS2=SGS2+AGS2) of an opponent, which corresponds to a sum of a single game score SGS2 acquired through a terminal of the opponent and an advertising game score AGS2 acquired by playing the advertising game that is provided during the online challenge.

The winner of the online challenge game may acquire a victory point related with the advertising game. When the accumulated victory point becomes a predetermined point, the accumulated victory point may be replaced with a gift card of a real price related with the advertising game. Here, the gift card represents an overall reward, and the gift card may include a gift coupon and a discount coupon in a form of a printed paper or a electronic file. A banner advertisement related with the gift card may be exposed on a display of the terminal during a process of playing a single game and a process of the online challenge.

The opponent may correspond to one of friends registered in the terminal of the challenger, invited friends, and individuals randomly selected among gamers of the single game. The individuals randomly selected among gamers of the single game may be selected through a challenger matching algorithm.

The provided advertising game may be selected by the challenger among at least one advertising game provided to the challenger based on a profile of the challenger.

The profile of the challenger may include at least one of name, age, geographical location, area of interest, e-mail address, social network service information, the number of registered friends, and a ranking information of the single game.

The provided advertising game may correspond to a HTML5 game.

An online challenge game system includes a plurality of terminals configured to acquire a single game score and an advertising game score, and an online challenge game server configured to communicate with the plurality of terminals to manage a challenge request and an acceptance of the challenge from each of the plurality of terminals, to provide an advertising game to the terminals of two individuals having an agreement of a challenge game, and to determine a winner of an online challenge game by comparing a total game score of one of the two individuals, which is calculated by summing the single game score and the advertising game score uploaded from the terminal of the one of the two individuals, with a total game score of the other one of the two individuals, which is calculated by summing the single game score and the advertising game score uploaded from the terminal of the other one of the two individuals.

Each of the plurality of terminals may include a display, an input device, a communication module, a storage device configured to store the single game score, the advertising game score, and the total game score, and a processor configured to perform a single game program and an online challenge game program. The online challenge game program may store the single game score in the storage device when a single game is played through the display and the input device, upload a challenge request to the online challenge game server through the communication module, download the advertising game from the online challenge game server, install the advertising game, upload the advertising game score acquired by playing the advertising game to the online challenge game server through the communication module, download the total game score and a result of the online challenge game from the online challenge game server, store the total game score and the result of the online challenge game in the storage device, and display the result of the online challenge game on the display. The online challenge game terminal may be one of a smart phone, a table personal computer, a laptop computer, and a portable device capable of connecting to an internet.

The processor may display a banner advertisement related with the advertising game on the display during a process of playing the single game and a process of the online challenge.

In addition, the processor may select an opponent in one of a friend challenge mode and a random challenge mode, the processor may select the opponent among a list of registered friends in the friend challenge mode, and the processor may select the opponent randomly in the random challenge mode.

In addition, the processor may display a game list including at least one advertising game on the display, and download a selected advertising game in the game list from the online challenge game server. The at least one advertising game included in the game list may have a characteristic matched with a profile of a user of the terminal.

The profile of the user of the terminal may include at least one of photograph, name, date of birth, address, area of interest, e-mail address, social network service information, the number of registered friends, and a ranking information of the challenge game.

The online challenge game server may include a database configured to store information of users of the online challenge game and information of the online challenge game, a communication module configured to communicate with the plurality of terminals, and a processor configured to perform an online challenge game management program. The online challenge game management program may receive the challenge request, which is uploaded from each of the plurality of terminals, through the communication module, transmit the challenge request to the terminal of an individual that the challenge request is targeted, provide the advertising game to the terminals of two individuals having an agreement of a challenge game, determine the winner of the online challenge game by comparing total game scores of the two individuals that are uploaded from the terminals of the two individuals, provide a result of the online challenge game and a victory point to the terminal of the winner, and replace an the accumulated victory point of the winner with a gift card of a real price when the accumulated victory point of the winner is determined to be a predetermined point with reference to the database.

The processor may provide a banner advertisement, which includes information about the victory point and the gift card provided by a sponsor, to the terminal when the terminal is connected to the online challenge game server. The processor may receive opponent selection information when the processor receives the challenge request from the terminal. In addition, in a random challenge mode, the processor may select the opponent among candidates for the challenge game using a matching algorithm.

The advertising games downloaded to the terminal may have a characteristic matched with a profile of a user of the terminal.

In a method for calculating an advertisement cost, a play time of an advertising game is counted, and an advertisement cost proportional to the counted play time of the advertising game is calculated. The calculating the advertisement cost may include calculating an average of the play time of the advertising game, and calculating the advertisement cost proportional to the average of the play time.

### Effects of the Inventive Concept

The online challenge game method of the inventive concept is capable of increasing user's interests since the online challenge game is performed in relation with the single game. In addition, the online challenge game method of the inventive concept attracts the users to play the online challenge game by providing a chance to acquire an additional game score through the advertising game. Therefore, effects of advertisements may be effectively increased. In addition, since the advertising cost is calculated in relation with the play time of the advertising game, the advertising cost may be proportional to an exposure time of the advertisement. Since the user gets a gift card based on the victory point acquired through the online challenge game, the users actively downloads the advertising game such that the advertising cost may be increased.

The foregoing effects is illustrative and is not to be construed as limiting thereof. Those skilled in the art will understand other effects of the example embodiments without materially departing from the novel teachings and advantages of the present inventive concept.

### BRIEF DESCRIPTION OF THE DRAWINGS

FIG. 1 is a diagram for describing an online challenge game system according to example embodiments.

FIG. 2 is a flow chart illustrating a method for online challenge game according to example embodiments.

FIG. 3 is a block diagram illustrating an example of an online challenge game system according to example embodiments.

FIG. 4 is a flow chart for describing a main program of an online challenge game performed on a processor of a server of FIG. 3.

FIGS. 5A and 5B are flow charts for describing an online challenge game management routine of FIG. 4.

FIGS. 6A to 6C are flow charts for describing a terminal program of an online challenge game performed on a terminal of FIG. 3.

FIGS. 7 to 15 are diagrams illustrating examples of screens displayed on a display device of a terminal.

### PARTICULAR CONTENTS FOR IMPLEMENTING THE INVENTIVE CONCEPT

Various example embodiments will be described more fully with reference to the accompanying drawings, in which some example embodiments are shown. The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

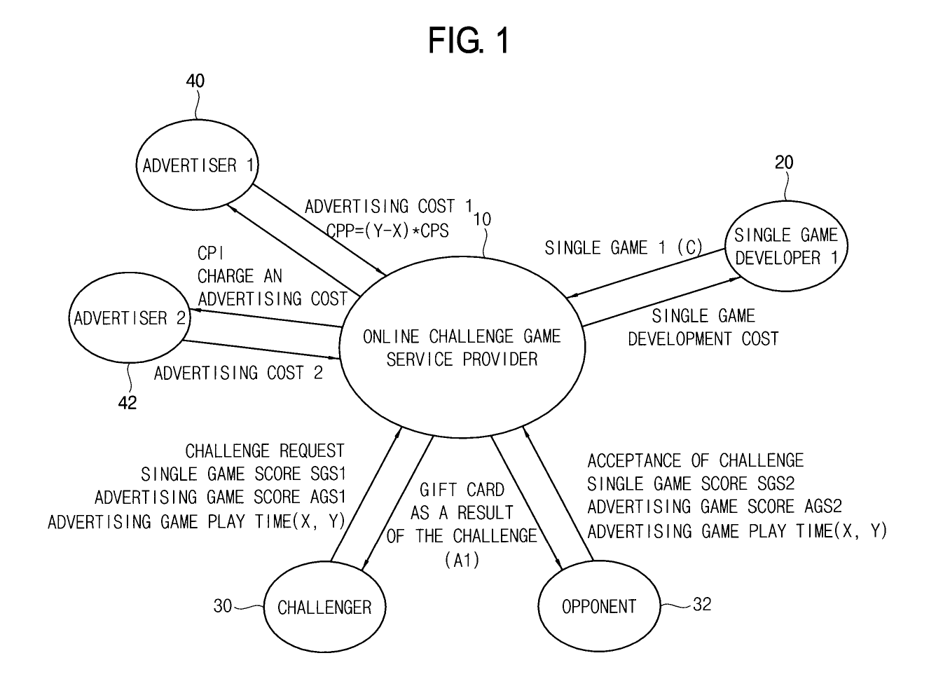

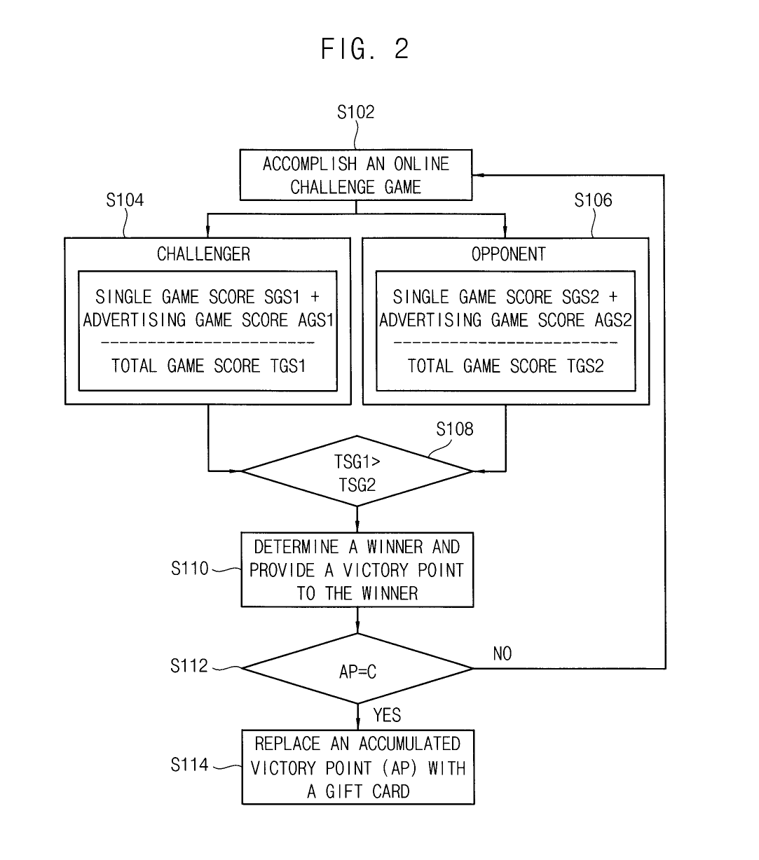

FIG. 1 is a diagram for describing an online challenge game system according to example embodiments, and FIG. 2 is a flow chart illustrating a method for online challenge game according to example embodiments.

Referring to FIG. 1, in an online challenge game system, an online challenge game service provider 10 distributes a single game, which is developed by a single game developer 20, to users, that is, to a challenger 30 and an opponent 32 at no charge or at a charge through an online game store. In addition, the service provider 10 attracts advertisers 40 and 42 for the single game. The service provider 10 registers a first advertising game and a second advertising game of the attracted advertisers 40 and 42, respectively, in an advertising game database. When the service provider 10 receives an online challenge game request from the challenger 30, the service provider 10 transmits the online challenge game request to the opponent 32. When the service provider 10 receives an acceptance of the challenge from the opponent 32, the service provider 10 presents the first advertising game and the second advertising game to both of the challenger 30 and the opponent 32, and provides a selected advertising game among the first advertising game and the second advertising game to both of the challenger 30 and the opponent 32. Hereinafter, it is assumed that the first advertising game is selected.

Referring to FIG. 2, when an online challenge game is accomplished (S102), the challenger 30 and the opponent 32 upload advertising game scores AGS1 and AGS2, which are acquired by playing the first advertising game, and single game scores SGS1 and SGS2 to the service provider 10. The service provider 10 calculates a total game score TGS1 by summing the advertising game score AGS1 and the single game score SGS1 of the challenger 30 (S104). In the same way, the service provider 10 calculates a total game score TGS2 by summing the advertising game score AGS2 and the single game score SGS2 of the opponent 32 (S106). The service provider 10 compares the total game score TGS1 of the challenger 30 and the total game score TGS2 of the opponent 32 (step S108). The service provider 10 determines one of the challenger 30 and the opponent 32 having a higher total game score as a winner of the online challenge game. If the challenger 30 is the winner, a victory point related with the first advertising game is provided to the challenger 30 (S110). The service provider 10 determines that the first advertising game is downloaded to and installed at each of the challenger 30 and the opponent 32, and counts the number of installations of the first advertising game.

When an accumulated victory point AP of the challenger 30 is equal to or greater than a certain number C (e.g., twenty) (S112), the accumulated victory point AP is replaced with a gift card (S114).

Referring again to FIG. 1, the service provider 10 may count the number of installs of the first advertising game as forty. The service provider 10 charges an advertising cost, which corresponds to forty times of the installation of the first advertising game, to the advertiser 40. The service provider 10 gives a portion of the paid advertising cost (A) to the single game developer 20 as a development cost (C), uses a portion of the paid advertising cost (A) as a gift card cost (A1), and considers the rest of the paid advertising cost (A) as a profit (X) of the service provider 10.

As described above, since the advertiser pays the advertising cost corresponding to the number of the installations of the advertising game, the advertiser is willing to pay the advertising cost.

In addition, since a time between a download of the advertising game to an upload of the advertising game score may be counted as an exposure time of the advertising game, the advertising cost may be determined to be proportional to the counted play time as well as to be proportional to the number of the installations. For example, as an average play time of the advertising game increases while the number of the installations is the same, the advertising cost may increase. In this way, the reliability of the determined advertising cost may increase since the advertising cost is determined to be proportional to the play time of the advertising game.

As described above, the users are able to play not only the single game but also the online challenge game, to select an advertising game from a plurality of advertising games, and to get a gift card of the advertiser using the accumulated victory point. Since the users get a high reward based on theirs efforts, the users may voluntarily enjoy the online challenge game.

Since the single game developer gets a steady and high development cost, the single game developer may actively develop more interesting single games.

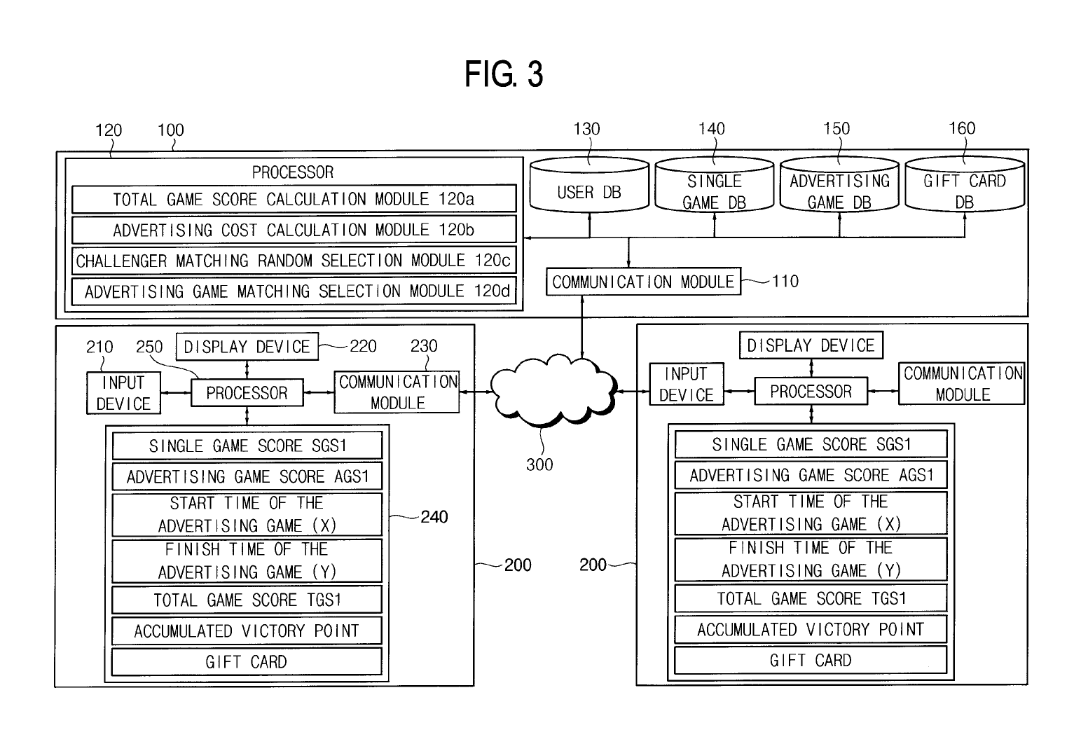

FIG. 3 is a block diagram illustrating an example of an online challenge game system according to example embodiments.

Referring to FIG. 3, an online challenge game system includes a service provider server 100 and a plurality of terminals 200.

The server 100 communicates with the plurality of terminals 200 by connecting to a wired or wireless network 300 through a communication module 110. The server 100 includes a processor 120, a user database 130, a single game database 140, an advertising game database 150, and a gift card database 160.

The processor 120 of the server 100 manages a game store and distributes a single game at no charge or at a charge through the game store. In some example embodiments, the single game may be embedded in the terminals instead of being downloaded from the game store. The processor 120 may include a total game score calculation module 120a, which performs a program of an online challenge game, accomplishes an online challenge game between the challenger and the opponent through receiving the online challenge game request from the challenger and receiving the acceptance of the challenge from the opponent, and calculates the total game scores of the challenger and the opponent by summing a respective single game score and a respective advertising game score, a advertising cost calculation module 120b, which calculates an advertising cost based on the number of downloads of the advertising game, a challenger matching random selection module 120c, and an advertising game matching selection module 120d.

The user database 130 stores personal information of the users of the online challenge game. The personal information may include ID, password, telephone number, name, date of birth, address, e-mail address, social network service (SNS) information, keyword about area of interest, the number of played online challenge games, the number of wins, victory point, the number of friends, ranking information, etc.

The single game database 140 manages single games. The single game database 140 may store programs of the single games, information of developers that developed the single games, date of registration, the number of downloads, information of users, ranking information, etc.

The advertising game database 150 manages advertising games. The advertising game database 150 may store programs of the advertising games, information of advertisers of the advertising games, information of developers, the number of downloads, information of users, total play time of the advertising games, etc.

The gift card database 160 manages information of gift cards that are issued. The gift card database 160 may store identifications of the gift cards, information of advertisers, price of each of the gift cards, the number of the gift cards that are issued, information of users, usage history of the gift cards, etc.

Here, the server 100 may include a web server, a database server, a communication server, an advertising cost calculation server, a challenge game operating server, a sponsor management server, a game developer management server, a management server, etc.

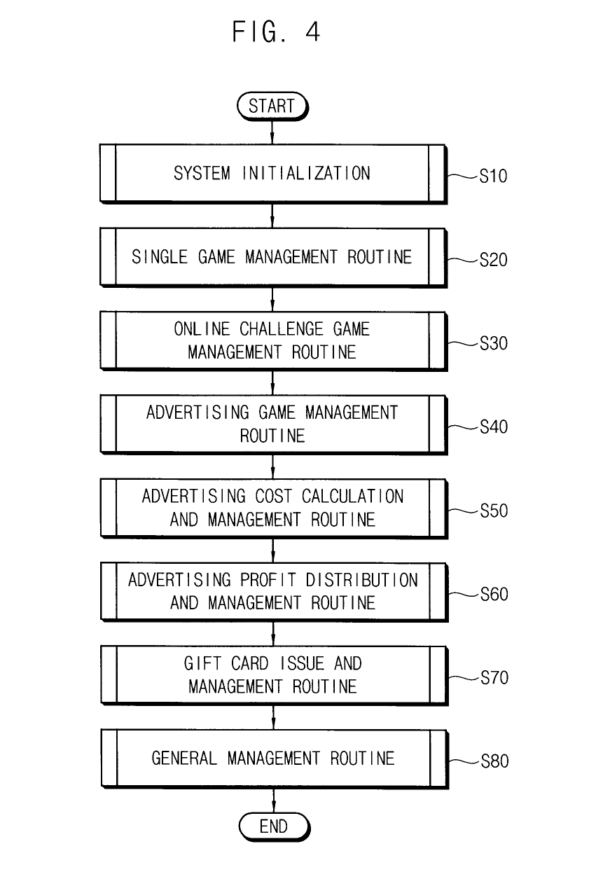

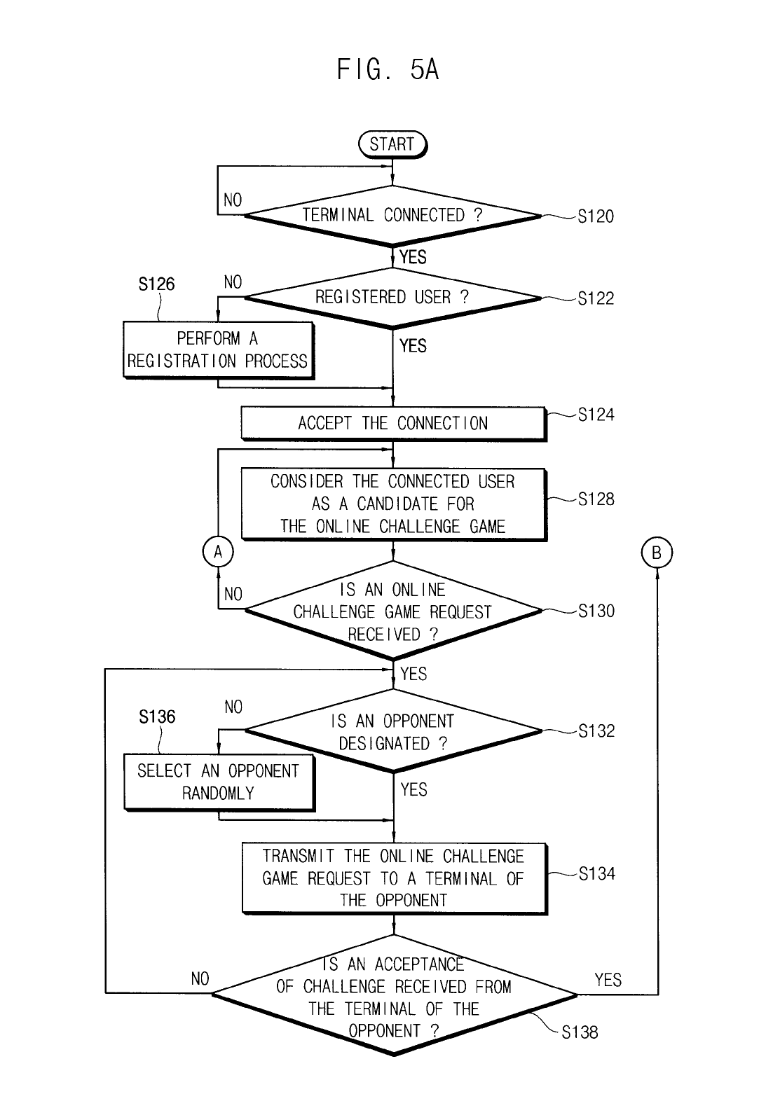

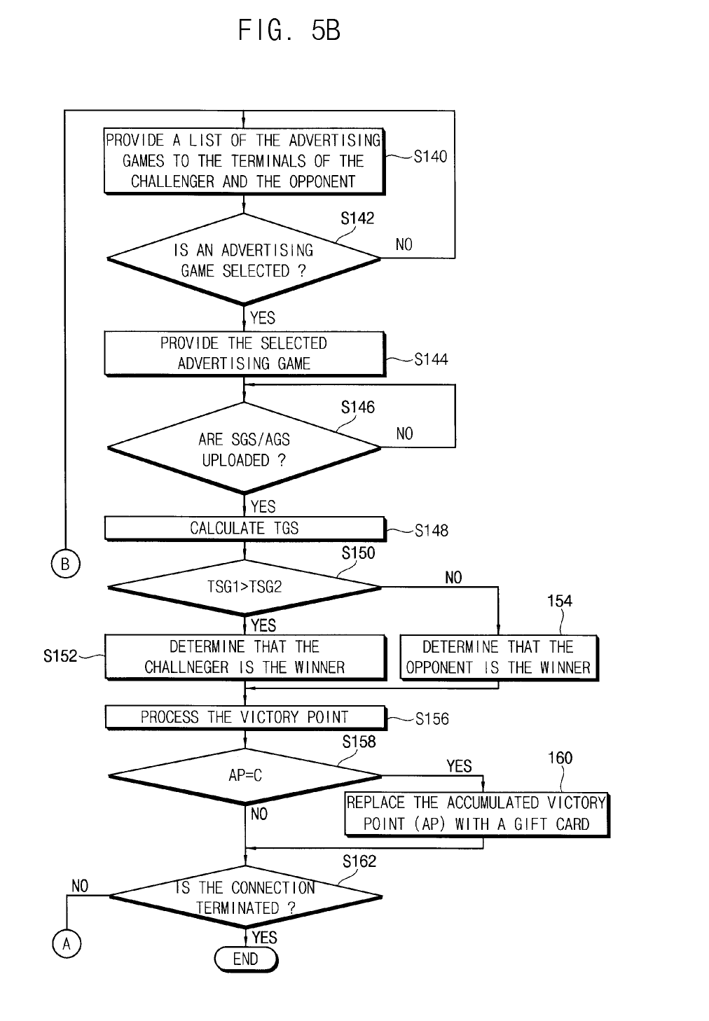

FIG. 4 is a flow chart for describing a main program of an online challenge game performed on a processor of a server of FIG. 3. FIGS. 5A and 5B are flow charts for describing an online challenge game management routine of FIG. 4.

Referring to FIG. 4, after system initialization (S10), a main program of the online challenge game performs a single game management routine (S20), an online challenge game management routine (S30), an advertising game management routine (S40), an advertising cost calculation and management routine (S50), an advertising profit distribution and management routine (S60), a gift card issue and management routine (S70), and a general management routine (S80).

The single game management routine (S20) manages the single games that are distributed at no charge or at a charge through the game store. The online challenge game management routine (S30) manages a process and a result of the online challenge game. The advertising game management routine (S40) manages uploads and downloads of the advertising games related with the advertisers. The advertising cost calculation and management routine (S50) calculates the advertising cost (cost per install; CPI) based on the number of installations of the advertising game, calculates the advertising cost (cost per play; CPP) based on the play time of the advertising game, charges the advertising cost to a corresponding advertiser, and manages the paid advertising cost.

The advertising cost CPP may be calculated using following [Equation].

CPP=Z*CPS, (Z=Y−X) [Equation]

Here, CPS represents an advertising cost per second, X represents a start time of the advertising game, Y represents a finish time of the advertising game, and Z represents a play time of the advertising game.

The terminal 200 may store the start time of the advertising game X and the finish time of the advertising game Y, and upload the start time X and the finish time Y to the server 100 together with the advertising game score.

The advertising profit distribution and management routine (S60) manages the distribution of the paid advertising cost to the single game developers according to a predetermined agreements. The gift card issue and management routine (S70) manages the number of the gift cards that are issued, terms of usage, places of usages, information of the users, etc. The general management routine (S80) manages operation and security of a system of the servicer provider.

Referring to FIGS. 5A and 5B, the online challenge game management routine (S30) is executed when receiving the online challenge game request from the terminal 200. That is, the processor 120 determines whether the terminal 200 is connected to the server 100 through the network 300 (S120). If the terminal 200 is connected to the server 100, the processor 120 determines whether the user of the terminal 200 is a registered user using ID and password (S122). If the user of the terminal 200 is a registered user, the processor 120 accepts the connection of the terminal 200 (S124). If the user of the terminal 200 is not a registered user, the processor 120 performs a registration process for the user (S126).

The processor 120 considers the connected user as a candidate for the online challenge game (S128). The processor 120 determines whether the processor 120 receives the online challenge game request from the terminal 200 (S130). If the online challenge game request is received from the terminal 200, the processor 120 determines whether an opponent is designated (S132). If an opponent is designated, the processor 120 transmits the online challenge game request to the terminal 200 of the designated opponent (S134). If an opponent is not designated, the processor 120 randomly selects an opponent among the candidates for the online challenge game (S136), and transmits the online challenge game request to the terminal 200 of the selected opponent (S134). In the step of S136, the processor 120 may provide a list of candidates for the online challenge game that are matched with a profile of the challenger using the challenger matching random selection module 120c.

The processor 120 determines whether the processor 120 receives an acceptance of the challenge from the terminal 200 of the opponent (S138). If the opponent denies to accept the challenge, the processor 120 performs the steps S132, S136, and S134 again.

If the processor 120 receives the acceptance of the challenge from the terminal 200 of the opponent, the processor 120 provides a list of the advertising games selected from the advertising game database 150 to the terminal 200 of the challenger and the terminal 200 of the opponent (S140). The list of the advertising games may be generated by the advertising game matching selection module 120d based on profiles of the challenger and the opponent.

The processor 120 determines whether the terminals 200 of the challenger and the opponent select the advertising game (S142), and provides a selected advertising game from the advertising game database 150 to the terminals 200 of the challenger and the opponent (S144).

If the single game scores SGS1 and SGS2 and the advertising game scores AGS1 and AGS2 are uploaded to the processor 120 from the terminals 200 of the challenger and the opponent (S146), the processor 120 calculates the total game scores TGS1 and TGS2 of the challenger and the opponent using the total game score calculation module 120a (S148). The processor 120 compares the total game score TGS1 of the challenger and the total game score TGS2 of the opponent (S150). If the total game score TGS1 of the challenger is greater than the total game score TGS2 of the opponent, the processor 120 determines that the challenger is the winner (S152). If the total game score TGS1 of the challenger is smaller than the total game score TGS2 of the opponent, the processor 120 determines that the opponent is the winner (S154).

The processor 120 increases the victory point of the winner by one, and stores the result in the database (S156). The processor 120 determines whether an accumulated victory point AP of the winner is equal to a gift card reward point C (S158). If the accumulated victory point AP of the winner is equal to the gift card reward point C, the processor 120 issues a gift card, which is related with the advertising game, to the winner such that information of the gift card is downloaded to the terminal 200 of the winner (S160). The processor 120 stores information of the issued gift card in the gift card database 160.

After finishing the steps S158 and S160, the processor 120 determines whether the connection of the terminal 200 is terminated (S162). If the connection of the terminal 200 is not terminated, the processor 120 returns to the step S128. If the connection of the terminal 200 is terminated, the processor 120 terminates the operation.

Referring again to FIG. 3, the terminal 200 may correspond to a smart phone, a feature phone, a table computer, etc.

The terminal 200 includes an input device 210, a display device 220, a communication module 230, a storage device 240, and a processor 250.

The input device 210 may include a user interface such as a keypad, a touch pad, etc., and generate a key input or a touch input for a game play, the online challenge game request, the acceptance of the challenge, etc.

The display device 220 may include a liquid crystal display (LCD) panel or an organic light emitting diode (OLED) display panel, and display graphic user interfaces.

The communication module 230 may include a cellular phone communication module such as 2G, 3G, and 4G communication or a data communication module such as wifi.

The storage device 240 includes a nonvolatile memory device such as a flash memory having a storage capacity of 2 GB to 32 GB. The storage device 240 stores the single game score SGS1, the advertising game score AGS1, the start time of the advertising game X, the finish time of the advertising game Y, the total game score TGS1, the accumulated victory point, the gift card information, etc.

The processor 250 executes a mobile operating system (OS), such as Symbian OS, Android OS from Google, IOS from Apple, Blackberry OS from RIM, Window OS from Microsoft, Linux OS, Web OS from HP, Bada from Samsung, MeeGo from Nokia, BREW from Qualcomm, etc., and an applications.

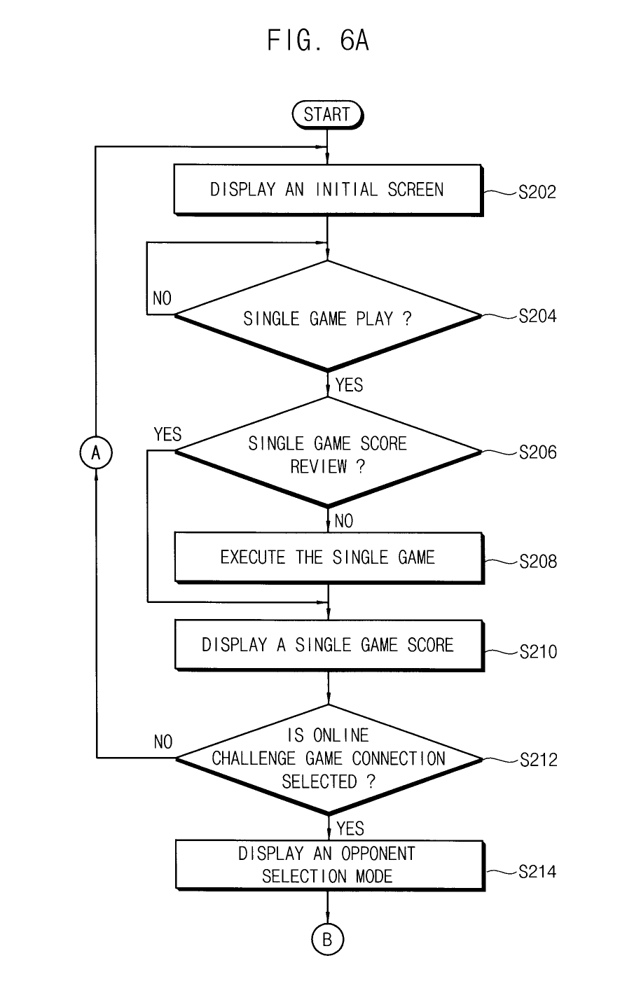

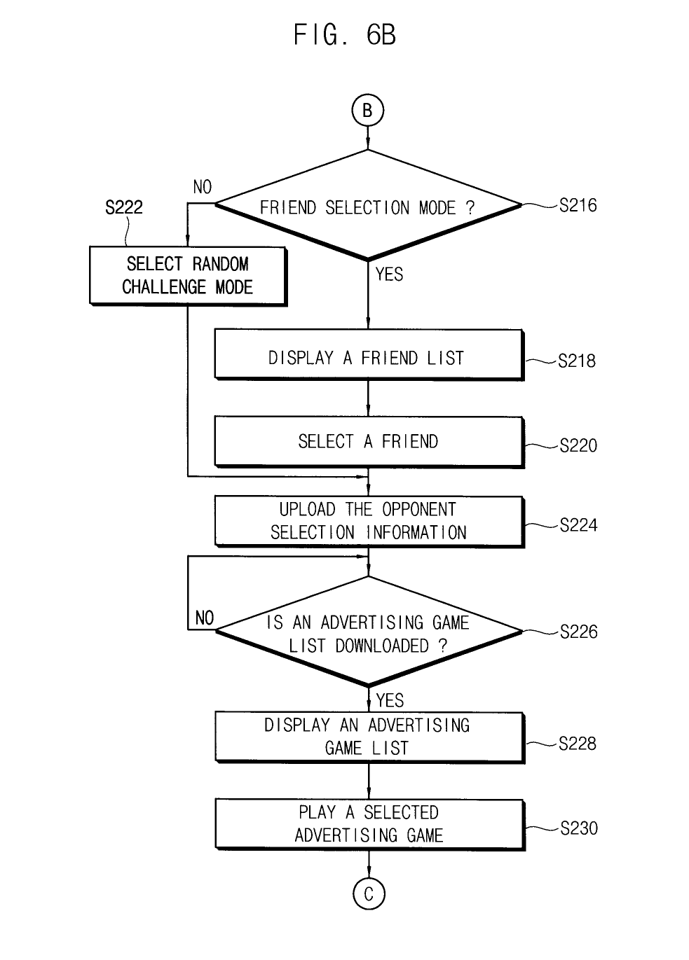

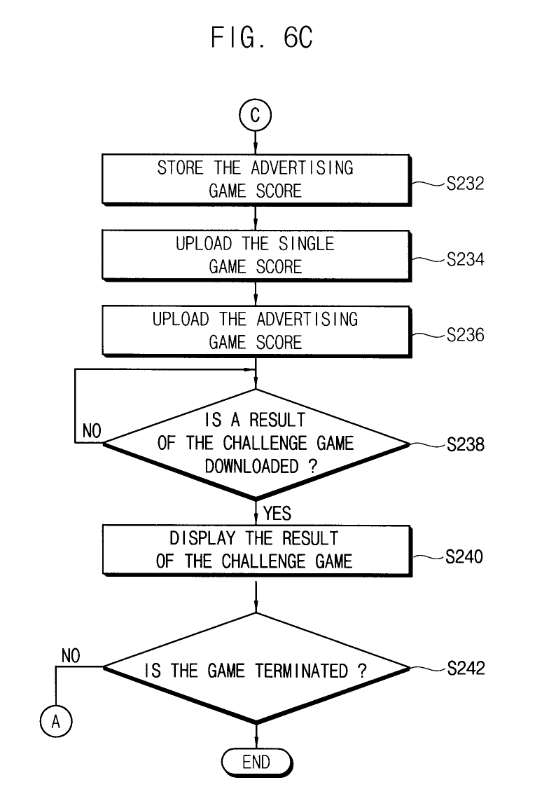

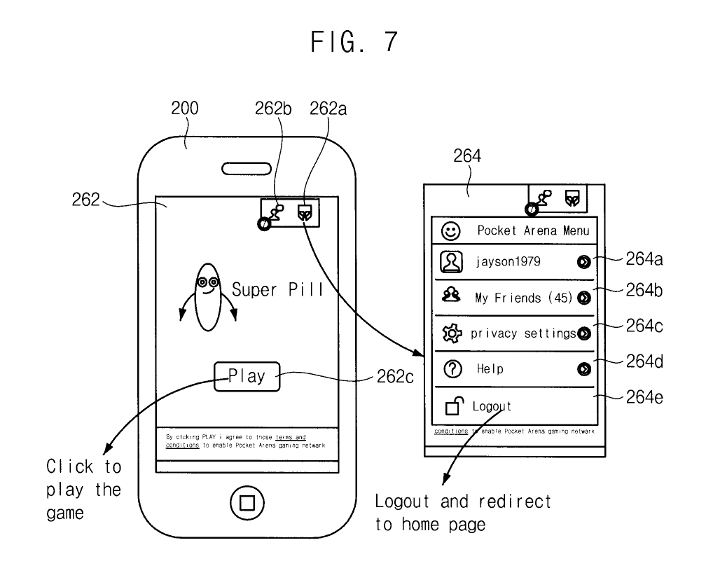

FIGS. 6A to 6C are flow charts for describing a terminal program of an online challenge game performed on a terminal of FIG. 3. FIGS. 7 to 15 are diagrams illustrating examples of screens displayed on a display device of a terminal.

Referring to FIGS. 6A to 6C, the terminal 200 displays an initial screen for a play of the single game (S202). For example, in an initial screen 262 illustrated in FIG. 7, a wallpaper of a single game “Super Pill” is displayed, a play touch button 262c is displayed in the middle of a bottom portion of the screen, and online challenge game icons 262a and 262b are displayed on an upper portion of the screen. When the online challenge game icon 262a is clicked, as illustrated in a right part of FIG. 7, a menu screen 264 of an online challenge game (Pocket Arena) is displayed. The menu screen 264 includes information of the challenger 264a, my friends 264b, privacy settings 264c, help 264d, and logout 264e.

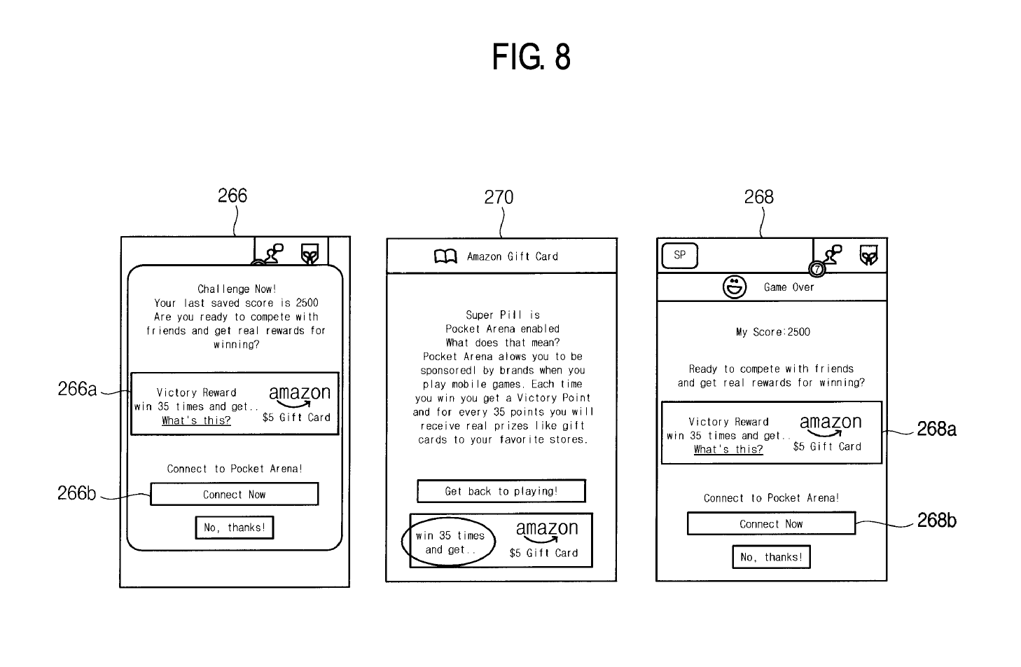

When the play touch button 262c is clicked (S204), the processor 250 asks whether the user wants to review the single game score (S206). If the single game score review is selected, as illustrated in FIG. 8, the processor 250 displays a single game score review screen 266 on the display device 220 (S210). If the single game score review is not selected, the processor 250 executes the single game (S208). After the single game is finished, as illustrated in FIG. 8, the processor 250 displays a game finish screen 268, which includes the final single game score, on the display device 220 (S210). In the single game score review screen 266, the final single game score “2500” is displayed, a banner advertisement 266a is displayed in the middle, and an online challenge game connection key 266b and a return key are displayed at the bottom. Similarly, in the game finish screen 268, the final single game score “2500” is displayed, a banner advertisement 268a is displayed in the middle, and an online challenge game connection key 268b and a return key are displayed at the bottom.

The banner advertisement 266a and 268a may include information about a gift card, such as information that the user is able to get a 5$ gift card of the advertiser when acquiring 35 victory points. When the banner advertisement 266a and 268a is clicked, a detailed description screen 270 of the banner advertisement 266a and 268a is displayed on the display device 220.

When the online challenge game connection key 266b and 268b is clicked on the single game score review screen 266 or the game finish screen 268 (S212), the terminal 200 is connected to the server 100 of the online challenge game system.

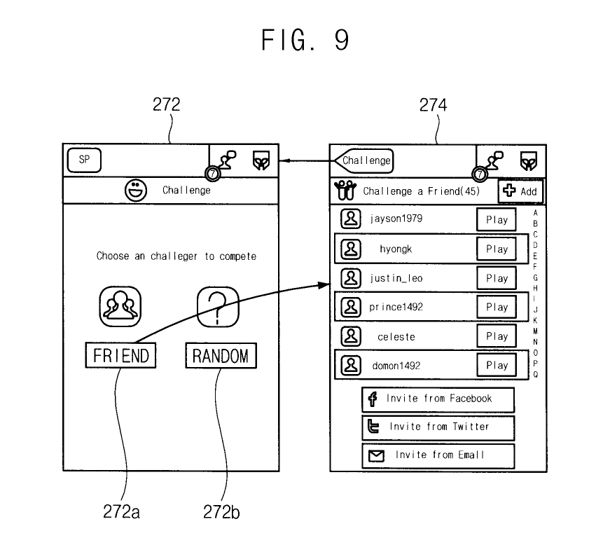

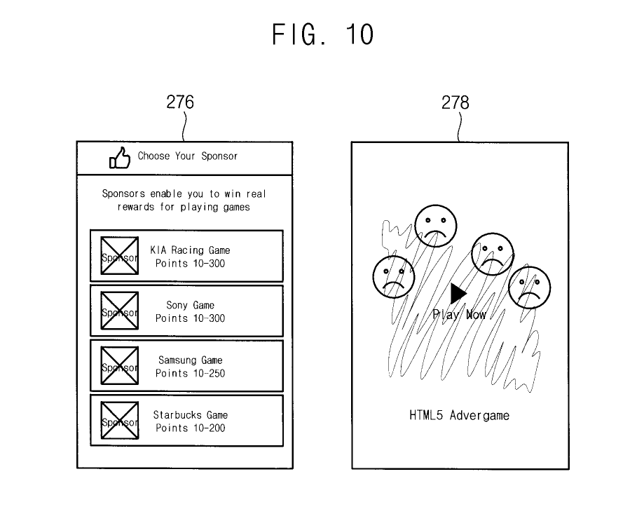

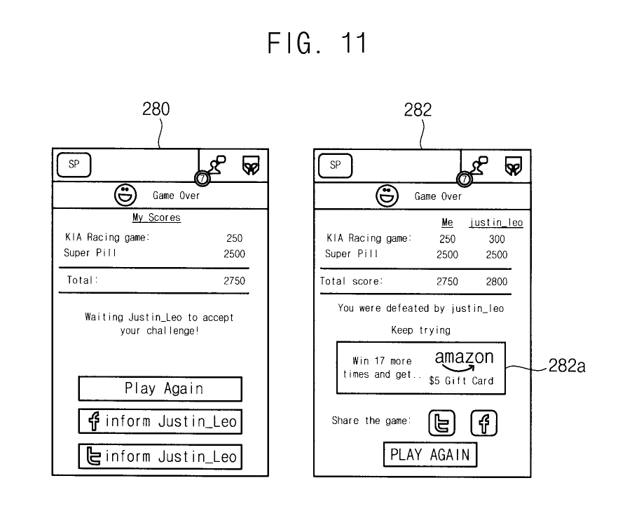

While the terminal 200 is connected to the server 100, as illustrated in FIG. 9, the processor 250 displays a challenge mode selection screen 272, in which the challenger selects one of a friend challenge mode and a random challenge mode, on the display device 220 (S214). The challenge mode selection screen 272 includes a friend challenge mode selection key 272a and a random challenge mode selection key 272b. When the friend challenge mode selection key 272a is clicked, a friend list screen 274 is displayed on the display device 220 (S218). As illustrated in FIG. 9, when “justin leo” is selected on the friend list screen 274 (S220), the selection information is uploaded to the server 100 (S224). After that, a sponsor list, that is, an advertising game list is downloaded from the server 100 to the terminal 200 (S226). As illustrated in FIG. 10, the processor 250 displays the downloaded sponsor list on a sponsor list screen 276 (S228). When an advertising game of a desired sponsor is selected on the sponsor list screen 276, HTML5 initial screen 278 of the advertising game is displayed. The advertising game is played by clicking a play key on the initial screen 278 (S230). The start time X of the advertising game is stored in a memory. As illustrated in FIG. 11, when the advertising game is finished, an advertising game finish screen 280 is displayed on the display device 220. Similarly, the finish time Y of the advertising game is stored in the memory. The total game score “2750” is displayed by summing the advertising game score “250”, which is acquired by playing the advertising game, and the single game score “2500”, and a message requiring to wait until the opponent “justin leo” accepts the challenge is displayed. The challenger may inform the challenge to the opponent through an e-mail or social network service, such as Twitter and Facebook, using information displayed at the bottom of the advertising game finish screen 280 to require the opponent to accept the challenge.

The acquired advertising game score “250” and the single game score “2500” is uploaded to the server 100 (S234 and S236). The start time X of the advertising game and the finish time Y of the advertising game are uploaded to the server 100 together with the score information. In some example embodiments, the summation of the advertising game score and the single game score may be performed by the server 100. In other example embodiments, the terminal 200 may sum the advertising game score and the single game score and upload the total game score to the server 100.

The processor 250 determines whether a result of the online challenge game is downloaded from the server 100 (S238). When the result of the online challenge game is downloaded from the server 100, a game result screen 282 is displayed on the display device 220 (S240). As illustrated in the game result screen 282 of FIG. 11, the total game score of the opponent (justin leo) is “2800=300+2500”, which is higher than the total game score “2750=250+2500” of the challenger (me), such that the challenger is determined as a loser. In addition, the banner advertisement 282a shows that 17 victory points is left for the challenger to acquire a $5 gift card. Therefore, the challenger is attracted to play the online challenge game continuously to acquire the $5 gift card.

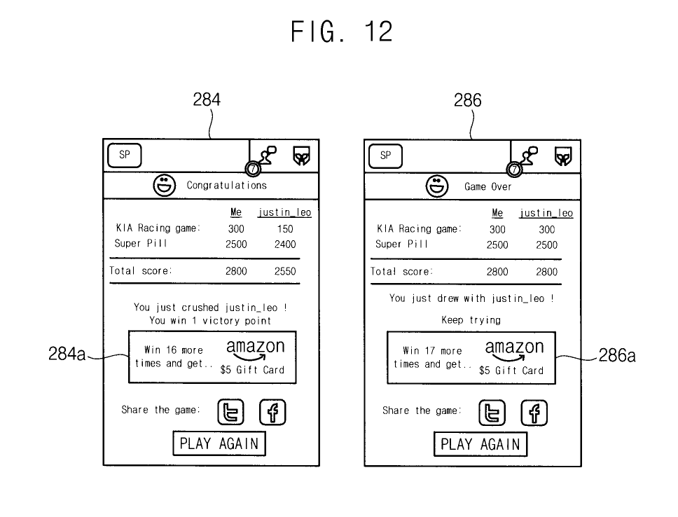

On the contrary, if the challenger is determined as a winner, a winner screen 284 of FIG. 12 is displayed on the display device 220. For example, in the winner screen 284 of FIG. 12, since the total game score of the challenger is “2800=300+2500” and the total game score of the opponent is “2550=150+2400”, it is displayed that the challenger acquired 1 victory point. Therefore, the banner advertisement 284a shows that 16 victory points is left for the challenger to acquire a $5 gift card.

When the online challenge game ends in a draw, a draw screen 286 of FIG. 12 is displayed on the display device 220. Therefore, the banner advertisement 284a shows that 17 victory points is left for the challenger to acquire a $5 gift card.

As described above, after displaying the result of the online challenge game (S240), the processor 250 terminates the online challenge game when the challenger selects to terminate the game, and otherwise, the processor 250 returns to the step S202.

In the step S216 of FIG. 6B, when the random challenge mode selection key 272b on the challenge mode selection screen 272 is clicked (S222), the processor 250 uploads a random challenge mode selection information to the server 100 (S224). Therefore, as described above, in the random challenge mode, the server 100 randomly selects an opponent using the challenger matching random selection module 120c and transmits the online challenge game request to the selected opponent.

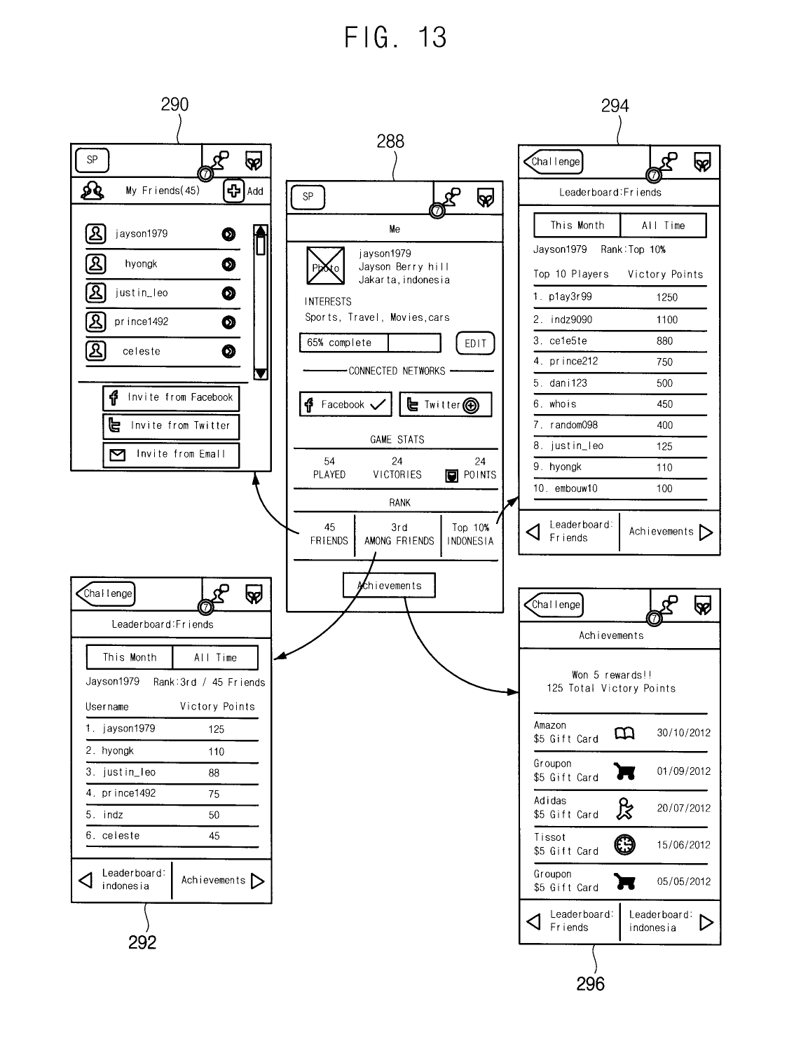

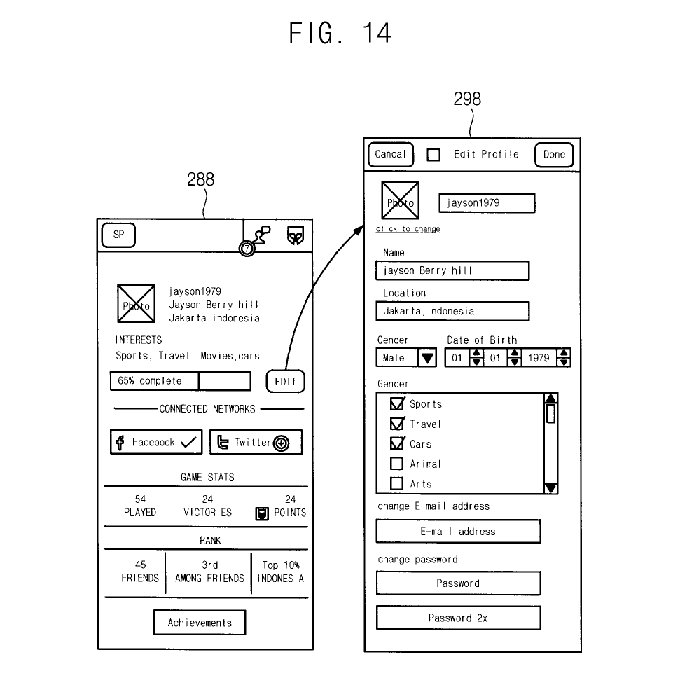

When the information of the challenger 264a on the menu screen 264 of FIG. 7 is clicked, a profile screen 288 of FIG. 13 is displayed on the display device 220. The profile screen 288 may include personal information, such as photograph, name, year of birth, address, area of interest, social network service (SNS) information, etc. In addition, the profile screen 288 may include contents of the online challenge game, such as the number of plays of the online challenge game, the number of wins, the victory point, the number of friends, ranking information among friends, local top ranking information, etc. When the number of friends is clicked, a friend list screen 290 is displayed. When the ranking information among friends is clicked, a friend ranking screen 292 is displayed. When the local top ranking information is clicked, a top ranking screen 294 is displayed. When an “achievement” key at the bottom of the profile screen 288 is clicked, an online challenge game record, and a list of rewarded gift cards or coupons for a gift may be displayed in a screen 296. The personal information of the profile screen 288 may be edited through an edit screen 298 of FIG. 14.

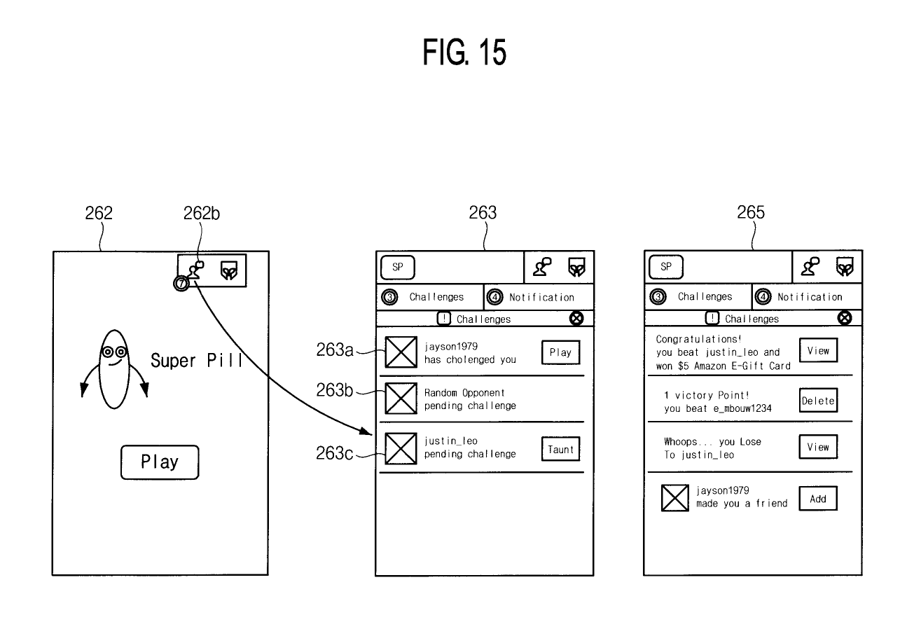

As illustrated in FIG. 15, when the online challenge game icon 262b on the initial screen 262 is clicked, a challenge acceptance request screen 263 is displayed on the display device 220. Selection keys for reviewing challenge contents and notifications are included at an upper portion of the challenge acceptance request screen 263. When the selection key for reviewing challenge contents is clicked, a challenge request from a friend 263a, a random challenge request 263b, and a challenge request of myself 263c may be displayed. When the challenge request from a friend 263a is clicked, the acceptance of the challenge is uploaded to the server 100 such that the online challenge game is accomplished. While waiting for an acceptance of opponents, “pending” is displayed at the random challenge request 263b and the challenge request of myself 263c.

When the selection key for reviewing notifications is clicked, a notification screen 265 of FIG. 15 is displayed. The notification screen 265 includes notifications, such as results of the challenges, events, campaign news, profile updates, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method for an online challenge game, comprising:
determining a winner by comparing a total game score (TGS1=SGS1+AGS1) of a challenger, which corresponds to a sum of a single game score SGS1 acquired through a terminal of the challenger and an advertising game score AGS1 acquired by playing an advertising game that is provided during an online challenge, with a total game score (TGS2=SGS2+AGS2) of an opponent, which corresponds to a sum of a single game score SGS2 acquired through a terminal of the opponent and an advertising game score AGS2 acquired by playing the advertising game that is provided during the online challenge.

2. The method of claim 1, wherein the winner of the online challenge game acquires a victory point related with the advertising game.

3. The method of claim 2, wherein, when the accumulated victory point becomes a predetermined point, the accumulated victory point is replaced with a gift card of a real price related with the advertising game.

4. The method of claim 3, wherein a banner advertisement related with the gift card is exposed on a display of the terminal during a process of playing a single game and a process of the online challenge.

5. The method of claim 1, wherein the opponent corresponds to one of friends registered in the terminal of the challenger, invited friends, and individuals randomly selected among gamers of the single game.

6. The method of claim 5, wherein the individuals randomly selected among garners of the single game are selected through a challenger matching algorithm.

7. The method of claim 1, wherein the provided advertising game is selected by the challenger among at least one advertising game provided to the challenger based on a profile of the challenger.

8. The method of claim 7, wherein the profile of the challenger includes at least one of name, age, geographical location, area of interest, e-mail address, social network service information, the number of registered friends, and a ranking information of the single game.

9. The method of claim 1, wherein the provided advertising game corresponds to a HTML5 game.

10. An online challenge game system, comprising:
a plurality of terminals configured to acquire a single game score and an advertising game score; and
an online challenge game server configured to communicate with the plurality of terminals to manage a challenge request and an acceptance of the challenge from each of the plurality of terminals, to provide an advertising game to the terminals of two individuals having an agreement of a challenge game, and to determine a winner of an online challenge game by comparing a total game score of one of the two individuals, which is calculated by summing the single game score and the advertising game score uploaded from the terminal of the one of the two individuals, with a total game score of the other one of the two individuals, which is calculated by summing the single game score and the advertising game score uploaded from the terminal of the other one of the two individuals.

11. The online challenge game system of claim 10, wherein each of the plurality of terminals includes:
a display;
an input device;
a communication module;
a storage device configured to store the single game score, the advertising game score, and the total game score; and
a processor configured to perform a single game program and an online challenge game program,
wherein the online challenge game program stores the single game score in the storage device when a single game is played through the display and the input device, uploads a challenge request to the online challenge game server through the communication module, downloads the advertising game from the online challenge game server, installs the advertising game, uploads the advertising game score acquired by playing the advertising game to the online challenge game server through the communication module, downloads the total game score and a result of the online challenge game from the online challenge game server, stores the total game score and the result of the online challenge game in the storage device, and displays the result of the online challenge game on the display.

12. The online challenge game system of claim 11, wherein the processor displays a banner advertisement related with the advertising game on the display during a process of playing the single game and a process of the online challenge.

13. The online challenge game system of claim 11, wherein the processor selects an opponent in one of a friend challenge mode and a random challenge mode, the processor selects the opponent among a list of registered friends in the friend challenge mode, and the processor selects the opponent randomly in the random challenge mode.

14. The online challenge game system of claim 11, wherein the processor displays a game list including at least one advertising game on the display, and downloads a selected advertising game in the game list from the online challenge game server.

15. The online challenge game system of claim 14, wherein the at least one advertising game included in the game list has a characteristic matched with a profile of a user of the terminal.

16. The online challenge game system of claim 15, wherein the profile of the user of the terminal includes at least one of photograph, name, date of birth, address, area of interest, e-mail address, social network service information, the number of registered friends, and a ranking information of the challenge game.

17. The online challenge game system of claim 11, wherein the downloaded advertising game corresponds to a HTML5 game.

18. The online challenge game system of claim 10, wherein the online challenge game server includes:
a database configured to store information of users of the online challenge game and information of the online challenge game;
a communication module configured to communicate with the plurality of terminals; and
a processor configured to perform an online challenge game management program,
wherein the online challenge game management program receives the challenge request, which is uploaded from each of the plurality of terminals, through the communication module, transmits the challenge request to the terminal of an individual that the challenge request is targeted, provides the advertising game to the terminals of two individuals having an agreement of a challenge game, determines the winner of the online challenge game by comparing total game scores of the two individuals that are uploaded from the terminals of the two individuals, provides a result of the online challenge game and a victory point to the terminal of the winner, and replaces an the accumulated victory point of the winner with a gift card of a real price when the accumulated victory point of the winner is determined to be a predetermined point with reference to the database.

19. The online challenge game system of claim 18, wherein the processor provides a banner advertisement, which includes information about the victory point and the gift card provided by a sponsor, to the terminal when the terminal is connected to the online challenge game server.

20. The online challenge game system of claim 19, wherein the processor receives opponent selection information when the processor receives the challenge request from the terminal.

21. The online challenge game system of claim 20, wherein, in a random challenge mode, the processor selects the opponent among candidates for the challenge game using a matching algorithm.

22. The online challenge game system of claim 18, wherein the advertising games downloaded to the terminal have a characteristic matched with a profile of a user of the terminal.

23. The online challenge game system of claim 22, wherein the profile of the user of the terminal includes at least one of name, age, geographical location, area of interest, e-mail address, social network service information, the number of registered friends, and a ranking information of the challenge game.

24. An online challenge game terminal, comprising:
a display;
an input device;
a communication module;
a storage device configured to store a single game score, an advertising game score, and a total game score; and
a processor configured to perform a single game program and an online challenge game program,
wherein the online challenge game program stores the single game score in the storage device when a single game is played through the display and the input device, uploads a challenge request to an online challenge game server through the communication module, downloads the advertising game from the online challenge game server, installs the advertising game, uploads the advertising game score acquired by playing the advertising game to the online challenge game server through the communication module, downloads the total game score and a result of the online challenge game from the online challenge game server, stores the total game score and the result of the online challenge game in the storage device, and display the result of the online challenge game on the display.

25. The online challenge game terminal of claim 24, wherein the online challenge game terminal is one of a smart phone, a table personal computer, a laptop computer, and a portable device capable of connecting to an internet.

26. An online challenge game server, comprising:
a database configured to store information of users of an online challenge game and information of the online challenge game;
a communication module configured to communicate with a plurality of terminals; and
a processor configured to perform an online challenge game management program,
wherein the online challenge game management program receives a challenge request, which is uploaded from each of the plurality of terminals, through the communication module, transmits the challenge request to the terminal of an individual that the challenge request is targeted, provides an advertising game to the terminals of two individuals having an agreement of a challenge game, determines the winner of the online challenge game by comparing total game scores of the two individuals that are uploaded from the terminals of the two individuals, provides a result of the online challenge game and a victory point to the terminal of the winner, and replaces an the accumulated victory point of the winner with a gift card of a real price when the accumulated victory point of the winner is determined to be a predetermined point with reference to the database.

27. A method for calculating an advertisement cost, comprising:
counting a play time of an advertising game; and
calculating an advertisement cost proportional to the counted play time of the advertising game.

28. The method of claim 27, wherein the calculating the advertisement cost includes:
calculating an average of the play time of the advertising game; and
calculating the advertisement cost proportional to the average of the play time.
